(19) United States
(12) Patent Application Publication
(10) Pub. No.: US 2026/0220013 A1
(43) Pub. Date: Jul. 30, 2026

(54) TEST SUPPORT DEVICE

(71) Applicant: Hitachi, Ltd., Tokyo (JP)

(72) Inventors: Yusuke NISHI, Tokyo (JP); Hideyuki SAKAI, Tokyo (JP); Jumpei NISHITANI, Tokyo (JP)

(21) Appl. No.: 19/320,058

(22) Filed: Sep. 5, 2025

(30) Foreign Application Priority Data
Jan. 28, 2025 (JP) 2025-011899

(51) Int. Cl. G06F 11/34; G06F 11/3668

(52) U.S. Cl. CPC G06F 11/3409; G06F 11/3688

(57) ABSTRACT

A test support device includes: a test execution unit that executes a performance test on a microservice; a resource cause determination unit that determines, in a case where it is determined from a result of the performance test that the microservice is poor in performance or/and a resource, whether a cause of being poor in the performance or/and the resource is in an application implemented in the microservice or in a resource of the microservice; and an application cause determination unit that determines, in a case where it is determined that the cause of being poor in the performance or/and the resource of the microservice is in the application implemented in the microservice, determines application processing that is a cause candidate from a relationship between the application process and the result of the performance test.

### CROSS-REFERENCE TO RELATED APPLICATION

The present application claims priority from Japanese application JP 2025-011899, filed on Jan. 28, 2025, the content of which is hereby incorporated by reference into this application.

### BACKGROUND OF THE INVENTION

### 1. Field of the Invention

The present invention relates to a test support device that supports a test of software, an information system, and the like.

### 2. Description of the Related Art

In an information system, each function of a conventional monolith becomes a microservice by a microservice (MS) technique, and components (application, CPU, memory, and the like) are increasing. Accordingly, cause analysis when performance degradation is detected in a performance test of a microservice becomes complicated. Therefore, efficient cause analysis/isolation and proposal of measures for improvement are required.

JP 2022-3507 A discloses that “a resource bottleneck module is determined” by measuring a change accompanying an increase in traffic of “operation type monitoring data” indicating a response capability of a service system and “resource type monitoring data” indicating a resource occupancy amount of the service system (service module) in a stress test. Further, JP 2022-3507 A discloses “estimating resource expansion demand information of the service system based on the resource type monitoring data”.

### SUMMARY OF THE INVENTION

In development of an information system or the like, a code defect of an application, incompleteness of a setting value, and performance degradation due to inappropriate method selection may occur. With respect to the code defect of an application, for example, if an application program is originally built with a high CPU usage rate in JSON format conversion, there is a case where the usage rate is always high even if the CPU is enhanced. The method selection is, for example, selection of a configuration of dividing the application in the JSON format conversion into two pieces or a configuration of combining the applications into one piece.

However, in the technique disclosed in JP 2022-3507 A, it is not possible to perform cause isolation or cause specifying of resources/applications for a code defect of an application, an incompleteness of a setting value, and performance degradation due to inappropriate method selection.

In view of the above circumstances, there has been a demand for a method capable of achieving cause isolation or cause specifying of resources/applications for performance degradation of a test target in a performance test.

In order to solve the above problems, a test support device according to an aspect of the present invention includes a test execution unit, a resource cause determination unit, and an application cause determination unit.

The test execution unit executes a performance test on the microservice as a test target, and acquires a result of the performance test.

In a case where the resource cause determination unit determines that the microservice is poor in performance or/and a resource from the result of the performance test, the resource cause determination unit determines whether a cause of being poor in the performance or/and the resource of the microservice is in an application implemented in the microservice or in the resource of the microservice.

In a case where it is determined that the cause of being poor in the performance or/and the resource of the microservice is in the application executed in the microservice, the application cause determination unit determines application processing as a cause candidate from a relationship between the application processing and the result of the performance test.

According to at least one aspect of the present invention, it is possible to improve the efficiency of the cause analysis of the resource/application at the time of performance degradation of the test target in the performance test.

Objects, configurations, and advantageous effects other than those described above will be clarified by the descriptions of the following forms for embodying the present invention.

### BRIEF DESCRIPTION OF THE DRAWINGS

FIG. 1 is a block diagram illustrating an example of a computation function of a test support device according to an embodiment of the present invention;

FIG. 2 is a block diagram illustrating an example of functions of the entire test support device according to the embodiment of the present invention;

FIG. 3 is a diagram illustrating a data configuration example of a performance test result information table in accordance with a test scenario 1 according to the embodiment of the present invention;

FIG. 4 is a diagram illustrating a data configuration example of a performance test result information table in accordance with a test scenario 2 and a test scenario 3 according to the embodiment of the present invention;

FIG. 5 is a diagram illustrating a data configuration example of a performance test result information table in accordance with a test scenario 4 according to the embodiment of the present invention;

FIG. 6 is a diagram illustrating a data configuration example of an application processing information table according to the embodiment of the present invention;

FIG. 7 is a diagram illustrating an example of sequential processing as an example of application processing;

FIG. 8 is a diagram illustrating an example of preferential control by MQ as an example of the application processing;

FIG. 9 is a diagram illustrating a data configuration example of a performance degradation causal information table according to the embodiment of the present invention;

FIG. 10 is a block diagram illustrating a hardware configuration example of the test support device according to the embodiment of the present invention;

FIG. 11 is a flowchart illustrating a procedure example of test support processing according to the embodiment of the present invention;

FIG. 12 is a diagram illustrating an example of selecting an attention MS with respect to an MS of a nested structure in Step S8 in FIG. 11;

FIG. 13 is a flowchart illustrating a procedure example of processing of specifying a cause candidate of the application processing in Step S9 of FIG. 11; and

FIG. 14 is a diagram illustrating an example of a display screen that displays the cause candidate of the application processing according to the embodiment of the present invention.

### DESCRIPTION OF THE PREFERRED EMBODIMENTS

Hereinafter, examples of modes for carrying out the present invention (referred to as “embodiment”) will be described with reference to the accompanying drawings.

In the present specification and the accompanying drawings, the same reference signs are given to common constituent elements or similar constituent elements, and redundant description will be omitted. In a case where there are a plurality of the same or similar constituent elements, the same reference signs may be attached with different subscripts for description. In a case where it is not necessary to distinguish the plurality of constituent elements, the description may be made by omitting the subscript. The number of constituent elements may be singular or plural unless otherwise specified.

In the following embodiments, various types of information will be described in a table format, but the various types of information may be in a data format other than the table format. For example, various names such as “XX information”, “XX table”, “XX list”, and “XX queue” are interchangeable therebetween.

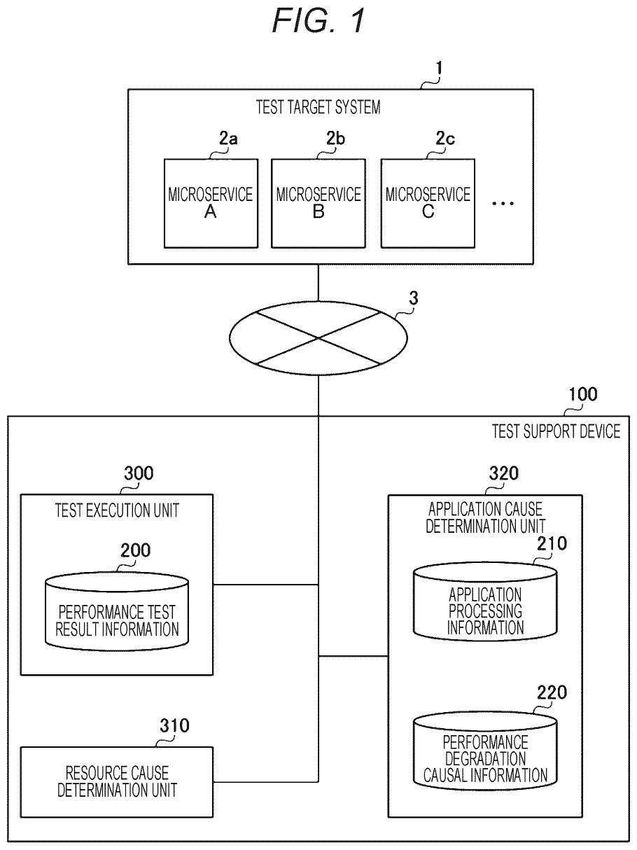

FIG. 1 is a block diagram illustrating an example of a computation function of a test support device according to an embodiment of the present invention.

In FIG. 1, a test support device 100 is a device that supports a test of software or an information system. In the present embodiment, the test support device 100 tests a test target system 1 via a public communication line 3.

The test target system 1 is an information system including a plurality of microservices such as microservices 2a, 2b, and 2c as an example. Hereinafter, the microservice 2a is referred to as “microservice A”, the microservice 2b is referred to as “microservice B”, and the microservice 2c is referred to as “microservice C”.

In the microservices technique, the whole is configured as a combination of independent “services” having a single function. The microservice is implemented in the information system as one computer resource (CPU, memory, OS, and the like). In general, one application (unit for executing a certain level of processing) is placed on one microservice. One application includes a plurality of types of processing (for example, functions, JSON format conversion, thread pool use processing, and the like). However, one type of processing may be placed on one microservice, and the processing may be divided into a plurality of microservices.

The test support device 100 includes a test execution unit 300, a resource cause determination unit 310, and an application cause determination unit 320 as computation functions for supporting the test of software or an information system.

The test execution unit 300 executes a performance test by applying a performance test program to a test target of the test target system 1. The test execution unit 300 stores the result of the performance test in a performance test result information table 200. The test execution unit 300 may check the test result and determine the performance of the test target.

The resource cause determination unit 310 determines whether or not the cause of performance degradation is in the resource, and the corresponding resource based on the determination result of the test execution unit 300.

In a case where the resource cause determination unit 310 determines that the cause of the performance degradation is not the resource (there is a cause in an application), the application cause determination unit 320 determines a cause candidate of the application processing. The application cause determination unit 320 acquires information regarding application processing of a microservice as the test target from an application processing information table 210. The application cause determination unit 320 determines the cause candidate of the application processing based on information regarding the application processing acquired from the application processing information table 210, a performance test result information table 200, and a performance degradation causal information table 220. In the present specification, an application may be abbreviated as an “application”.

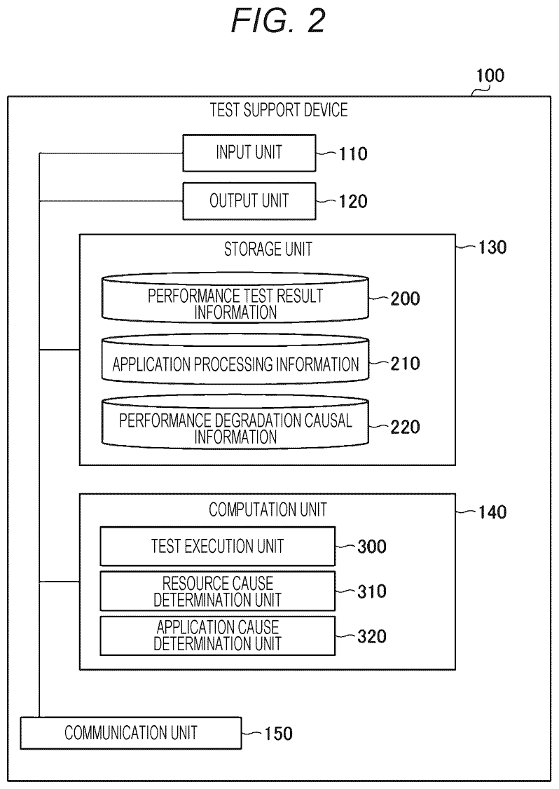

FIG. 2 is a block diagram illustrating an example of functions of the entire test support device according to the embodiment of the present invention.

The test support device 100 includes an input unit 110, an output unit 120, a storage unit 130, a computation unit 140, and a communication unit 150.

The input unit 110 has a function of inputting various types of information to the test support device 100.

The output unit 120 has a function of outputting a computation result of the computation unit 140 and various types of information stored in the storage unit 130.

The storage unit 130 has a function of storing various types of information. As illustrated in FIG. 2, the storage unit 130 stores the performance test result information table 200, the application processing information table 210, and the performance degradation causal information table 220 illustrated in FIG. 1.

The computation unit 140 has a function of executing computation for supporting a test of software or an information system. As illustrated in FIG. 2, the computation unit 140 includes the test execution unit 300, the resource cause determination unit 310, and the application cause determination unit 320 illustrated in FIG. 1.

The communication unit 150 has a function of performing communication between the test support device 100 and the public communication line 3.

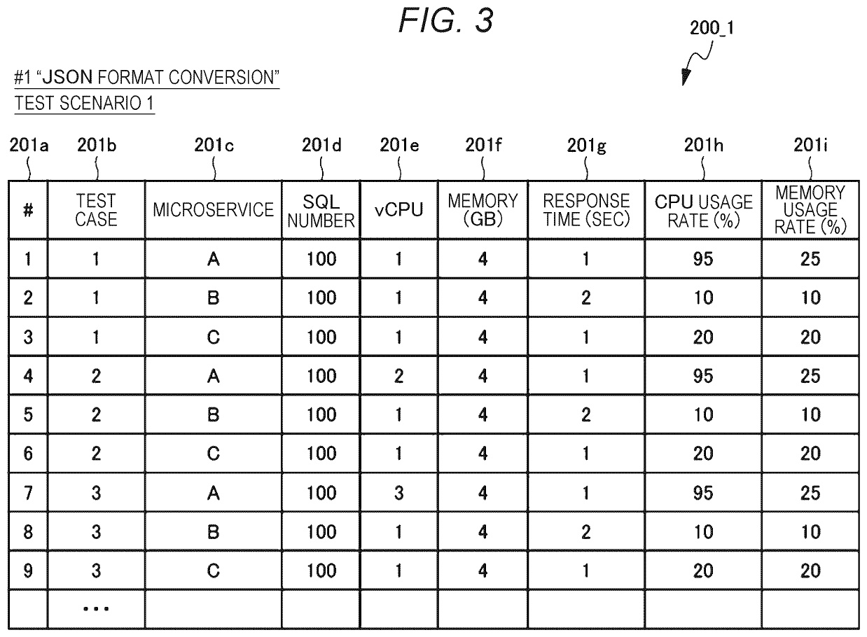

Next, the performance test result information table 200 will be described with reference to FIGS. 3 to 5.

In the performance test, a resource (CPU, memory, and the like) allocated to the microservice of the test target system 1 is changed for a specific test scenario, and the performance test is repeated a plurality of times. In the present embodiment, the following example is prepared as a test scenario.
Test scenario 1: Perform user registration processing 50 cases/minute (assuming normal time)
Test scenario 2: Perform online search processing 100 times/minute (assuming normal time)
Test scenario 3: Perform online search processing 500 times/minute (assuming peak time)
Test scenario 4: Perform transaction registration processing 20 times/minute (assuming normal time) For example, in a hotel reservation service, when a campaign is launched in a travel season, a large amount of access temporarily concentrates on a hotel reservation site.

FIG. 3 is a diagram illustrating a data configuration example of the performance test result information table in accordance with the test scenario 1 according to the embodiment of the present invention. A performance test result information table 200_1 illustrated in FIG. 3 is a test result of the performance test in accordance with the test scenario 1, and is an example in a case where the application processing is “JSON format conversion”. JSON (JavaScript Object Notation) is a text-based data format to which object notation in JavaScript is applied. The test on “JSON format conversion” is an example of a unit test. In the case of “JSON format conversion”, application processing by an MS alone, and performance degradation causal information and performance test result information for the corresponding MS (application processing) are used.

The performance test result information table 200_1 includes data items of “identification information (#)”, “test case”, “microservice”, “SQL (Structured Query Language) number”, “vCPU”, “memory (GB)”, “response time”, “CPU usage rate”, and “memory usage rate”.

An identification information field 201a stores information for identifying a record of the performance test result information table. In this example, the identification information of the record is a number, but is not limited to this example. As the identification information, an expression such as a name and an ID may be used. A test case field 201b stores information for identifying a test case performed by changing resources in the same test scenario. In this example, the identification information of the test case is a number, but is not limited to this example.

A microservice field 201c stores information indicating a microservice on which a performance test has been performed.

An SQL number field 201d stores information indicating the number of times that an SQL statement used by a database management system (DBMS) is issued.

A vCPU field 201e stores information (for example, the number of vCPUs and the like) regarding a vCPU (virtual CPU). The vCPU is a resource that functions as a CPU of a computer when viewed from software that operates on a virtualized computer. The vCPU is configured by distributing resources constituting a physical CPU.

A memory field 201f stores information regarding the memory (for example, a memory capacity (GB) and the like).

Each of the SQL number, the vCPU, and the memory described above is information regarding a test condition.

A response time field 201g stores information indicating a response time (seconds) of the microservice (application processing) when the performance test is performed.

A CPU usage rate field 201h stores information indicating a usage rate (%) of the CPU by the microservice (application processing) when the performance test is performed.

A memory usage rate field 201i stores information indicating a usage rate (%) of the memory by the microservice (application processing) when the performance test is performed.

The response time, the CPU usage rate, and the memory usage rate described above are information regarding a test result.

Each piece of information in a test case 1 (records #1 to #3) is a test condition of a first-time performance test on microservices A to C and an acquired test result. Each piece of information in a test case 2 (records #4 to #6) is a test condition of a second-time performance test on microservices A to C and an acquired test result. Each piece of information in a test case 3 (records #7 to #9) is a test condition of a third-time performance test on microservices A to C and an acquired test result.

In the test cases 1 to 3 of the test scenario 1, the SQL number is constant (100) with respect to the microservices A to C, and only the resource (the number of vCPUs) of the microservice A is changed. Regarding the microservice A, even when the performance test is performed by increasing the number of vCPUs (1→2→3), the test result does not change, and the CPU usage rate remains as high as “95%”.

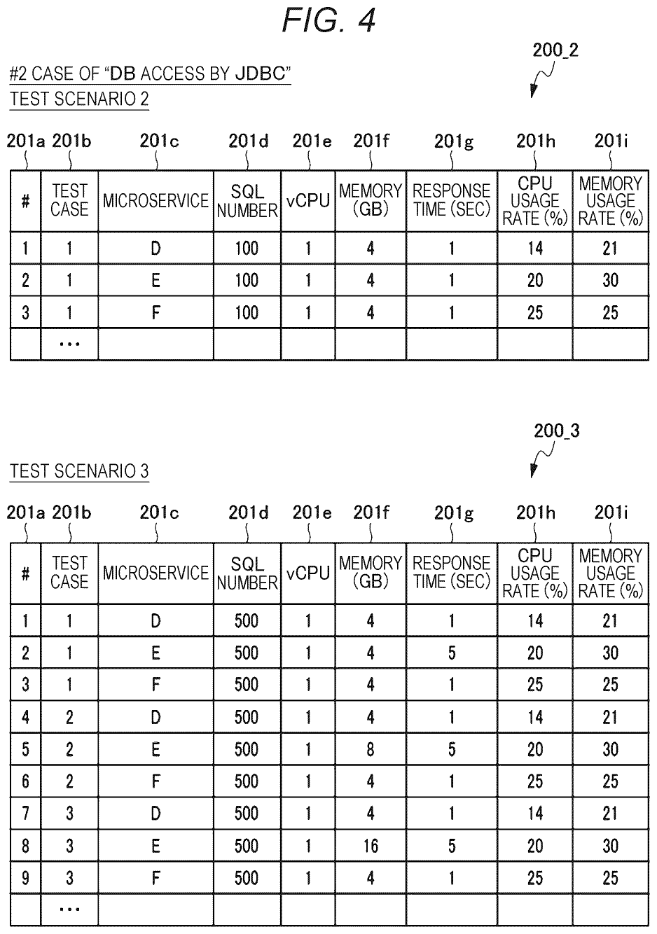

FIG. 4 is a diagram illustrating a data configuration example of the performance test result information table in accordance with the test scenario 2 and the test scenario 3 according to the embodiment of the present invention. An upper part of FIG. 4 illustrates a performance test result information table 200_2 in accordance with the test scenario 2, and a lower part of FIG. 4 illustrates an example of a performance test result information table 200_3 in accordance with the test scenario 3.

The performance test result information tables 200_2 and 200_3 illustrated in FIG. 4 are test results of the performance test in accordance with the test scenarios 2 and 3, and are examples in a case where the application processing is “DB access by JDBC”. The Java DataBase Connectivity (JDBC) is one of standard interfaces (API) for accessing a database from a Java program. A test on “DB access by JDBC” is an example of an integration test. In the case of “DB access by JDBC”, application processing including the relation between the MSs and performance degradation causal information for the corresponding MS (application processing), and performance test result information are used.

In the performance test result information table 200_2 (the upper part of FIG. 4) in accordance with the test scenario 2, the SQL number is 100 (at normal time). In the test scenario 2, response times of microservices D to F are “1 second”.

In the performance test result information table 200_3 (the lower part of FIG. 4) in accordance with the test scenario 3, the SQL number is 500 (peak time). In the test cases 1 to 3 of the test scenario 3, the SQL number is constant (500) with respect to the microservices D to F, and only the resource (memory capacity) of the microservice E is changed. For a microservice E, the test result is not changed (the response time remains “5 seconds”) even if the memory capacity is increased (4→8→16 GB).

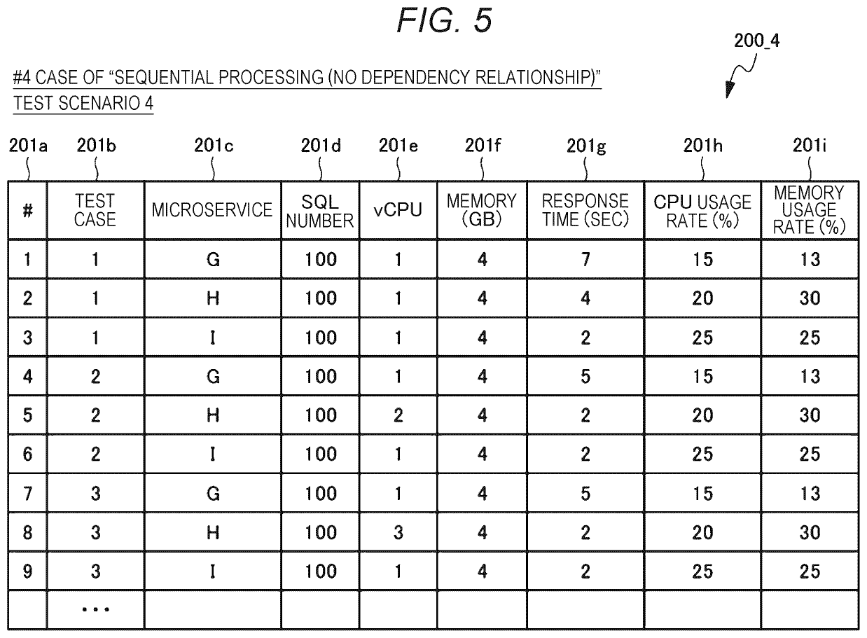

FIG. 5 is a diagram illustrating a data configuration example of the performance test result information table in accordance with the test scenario 4 according to the embodiment of the present invention. A performance test result information table 200_4 illustrated in FIG. 5 is a test result of the performance test in accordance with the test scenario 4, and is an example in a case where the application processing is “sequential processing (without dependency relationship)”. The test on “sequential processing (without dependency relationship)” is an example of a system test. In “sequential processing (without dependency relationship)”, a plurality of microservices cooperating with a target microservice perform sequential processing. In the case of “sequential processing (without dependency relationship)”, application processing including the relation between the MSs and performance degradation causal information for the corresponding MS (application processing), and performance test result information are used. At this time, the business logic and an MS group may be included in the relation between the MSs.

In the performance test result information table 200_4, the performance test was performed on microservices G to I in a plurality of test cases by changing the resources. In the example of FIG. 5, regarding a microservice H, when the number of vCPUs is increased (1→2→3), the response time is shortened (4→2→2 seconds), and a part of the performance is improved.

In the present specification, in a case where it is not necessary to distinguish the performance test result information tables 200_1 to 200_4, these tables are collectively referred to as a performance test result information table 200.

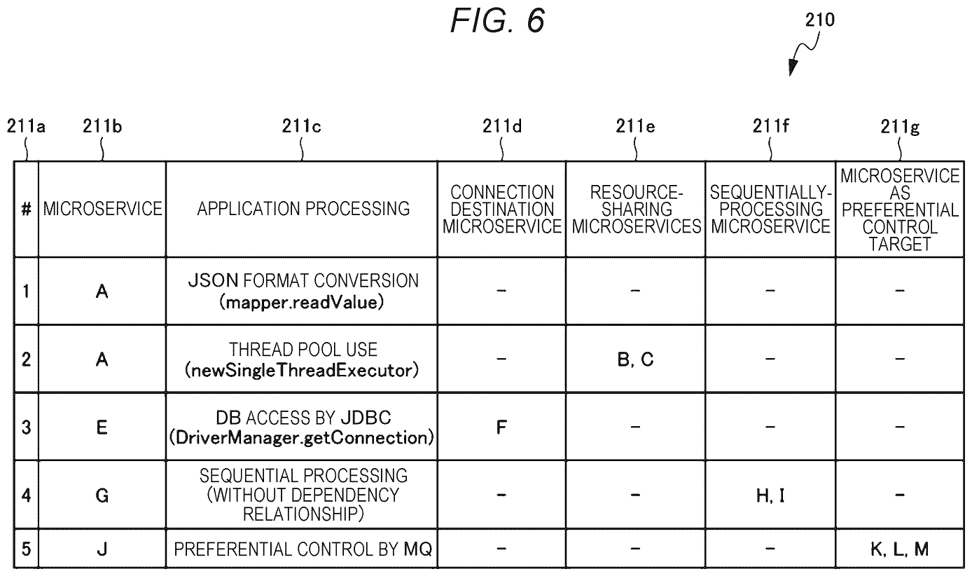

Next, the application processing information table 210 will be described with reference to FIG. 6.

FIG. 6 is a diagram illustrating a data configuration example of the application processing information table 210 according to the embodiment of the present invention.

The application processing information table stores information regarding application processing performed by the microservice. The information regarding the application processing is defined in advance from, for example, a specification of an application programming interface (API), a result obtained by performing parsing (analysis and conversion) on the codes of the application, and the like. The API is a rule defining a procedure, a data format, and the like for calling and using a function of a certain computer program (software), data to be managed, and the like from another external program. The application processing information table may include not only the relation in processing between microservices but also setting values of functions (distributed transactions, autoscale, and the like) of the microservices.

The application processing information table 210 illustrated in FIG. 6 includes data items of “identification information (#)”, “microservice”, “application processing”, “connection destination microservice”, “resource-sharing microservice”, “sequentially-processing microservice”, and “microservice as preferential control target”.

An identification information field 211a stores information for identifying a record of the application processing information table. In this example, the identification information is a number, but is not limited to this example,

A microservice field 211b stores information indicating a target microservice.

An application processing field 211c stores information indicating the content of processing executed for each target microservice or application. Information of the application processing is expressed by, for example, a function of a program, a name of a Java library or an API, or the like.

Each piece of information of the microservice and the application processing described above can be extracted from, for example, an API specification, a Java library, or the like.

A connection destination microservice field 211d stores information indicating a connection destination microservice connected to the target microservice.

A resource-sharing microservice field 211e stores information indicating a microservice that shares a resource with the target microservice.

A sequentially-processing microservice field 211f stores information indicating a microservice that cooperates with the target microservice and performs sequential processing.

A field 211g of the microservice as a preferential control target stores information indicating a microservice as a target of preferential control in accordance with message queuing (MQ).

The sequentially-processing microservice and the microservice as the preferential control target are examples in which communication and processing having a dependency relationship between the MSs are not directly performed, but the performance of the target MS is affected. These microservices maintain a relation based on the business logic. The business logic is, for example, a processing content or a processing flow specific to business. By reflecting the business logic in the relation between the MSs, it is possible to realize a performance test more conforming to the business. These microservices may constitute an MS group (one application function).

Each piece of information of the connection destination microservice, the resource-sharing microservice, the sequentially-processing microservice, and the microservice as preferential control target, which have been described above, can be extracted from, for example, a setting value such as a parameter indicating the connection destination of the target microservice.

In FIG. 6, information regarding application processing of the microservices A to J is registered. In the application processing field 211c, “JSON format conversion (mapper. readValue)” and “thread pool use (newSingleThreadExecutor)” are shown as examples of application processing of the microservice A. A thread pool is a mechanism in which the number of threads scheduled to be processed is reserved in advance. In the thread pool use, the related MS shares the number of reserved threads, and thus the related MSs contend for processing power. As an example of the thread pool, there is a Java thread pool. The related MS refers to an MS whose processing or a resource has a relation with a processing MS. For example, an MS connected from the processing MS, an MS sharing a resource with the processing MS, or the like corresponds to the related MS.

Similarly, “DB Access with JDBC (DriverManager. getConnection)” is shown as an example of the application processing of the microservice E. Further, “sequential processing (without dependency relationship)” is shown as an example of the application processing of the microservice G, and “preferential control by MQ” is shown as an example of the application processing of the microservice J.

In a case where the application processing of the microservice A is “JSON format conversion”, there is no related MS. In a case where the application processing of the microservice A is “thread pool use”, resource-sharing microservices are an MS B and an MS C. In the case of “DB access by JDBC” of the microservice E, the connection destination microservice is an MS F. In the case of “sequential processing (without dependency relationship)” of the microservice G, sequentially-processing microservices are an MS H and an MS I. In the case of “preferential control by MQ” of the microservice J, microservices as the preferential control target are an MS K, an MS L, and an MS M.

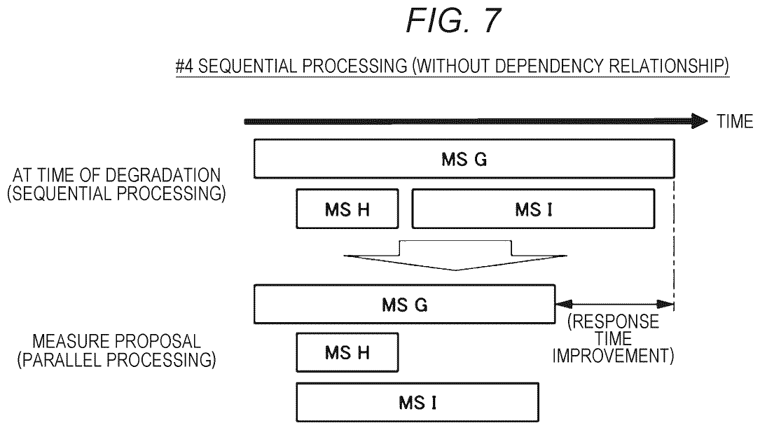

FIG. 7 is a diagram illustrating an example of sequential processing as an example of the application processing. The horizontal axis is a time axis of processing.

In FIG. 7, it is assumed that the microservice G (MS G) is related to the microservice H (MS H) and the microservice I (MS I). For example, in a case where the MS G is screen processing, the MS G is the business logic that receives the processing results of the MS H and the MS I and creates/displays screen data. The MS H and the MS I are sequentially processed in this order, and the MS G waits for completion of the MS I and executes the processing. However, the MS G waits for the completion of the MS I, thereby having a long response time. This state can be said to be a state in which performance is degraded.

Therefore, in a case where the MS H and the MS I have no dependency relationship with each other and the MS H and the MS I can be processed in parallel, it is conceivable to process the MS H and the MS I in parallel as a measure proposal. The MS G receives the processing result from each MS as soon as the MS H and the MS I are completed. As a result, the MS G can improve the response time by an amount at which the MS I accelerates the start of processing without waiting for the end of the MS H. In addition, resource enhancement is also an effective measure.

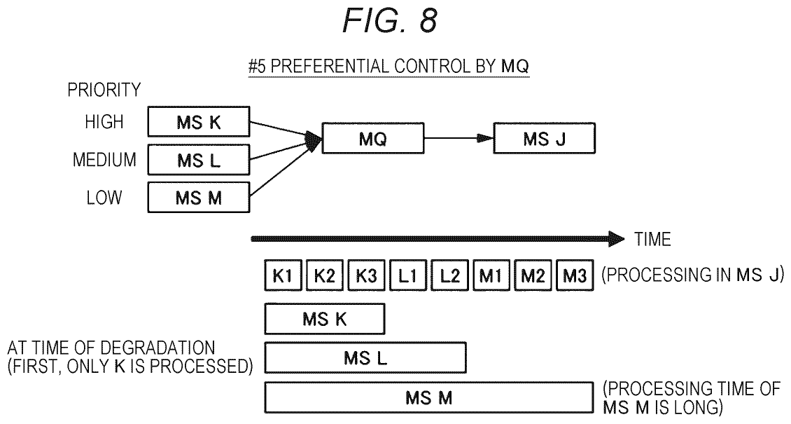

FIG. 8 is a diagram illustrating an example of preferential control by the MQ as an example of the application processing. The horizontal axis is a time axis of processing.

In FIG. 8, it is assumed that the microservice J (MS J) is related to a microservice K (MS K), a microservice L (MS L), and a microservice M (MS M). For example, the MS J is an MS that receives processing results of the MS K, the MS L, and the MS M of different users and performs image conversion processing, mail transmission, and the like. Here, the MS M can be used by a user being a free member, and the MS L and the MS K can be used by a user being a pay member. Further, the MS K can be used only by users being premium pay members who have paid a higher fee among the pay members. Therefore, the priority of the processing on the system is set to be higher in the order of the MS K>the MS L>the MS M.

MQ illustrated in FIG. 8 represents a dedicated data storage area managed by software or the like that mediates the MS K to the MS M and the MS J. The MS J reads data written in the MQ by the MS K to the MS M from the MQ in accordance with the set priority. By finely adjusting and changing this priority, for example, the processing time of the MS M having a long processing time is shortened. However, there is also a possibility that processing of another microservice such as the MS L that originally has a higher priority than the MS M is delayed.

For example, at the time of performance degradation, only the MS K with a high priority is processed first, and then the MS L and the MS M are processed in this order. For example, it is assumed that the processing results of the MS K are “MS K1”, “MS K2”, and “MS K3”, the processing results of the MS L are “MS L1” and “MS L2”, and the processing results of “MS M” are “MS M1”, “MS M2”, and “MS M3”. In the MS J, the processing is executed in the order of “MS K1”, “MS K2”, “MS K3”, “MS L1”, “MS L2”, “MS M1”, “MS M2”, and “MS M3”.

Here, the priority is adjusted, and, in the MS J, the MS L and the MS M are processed in parallel after the MS K is processed. For example, by processing “MS L1”, “MS M1”, “MS L2”, “MS M2”, and “MS M3” in this order, the processing result “MS M1” of a part of the MS M is processed earlier than the processing result “MS L2” of the MS L. Alternatively, in order to improve the satisfaction level of the user of the MS M, it is conceivable to temporarily set the priority of the MS M to be higher than that of the MS L.

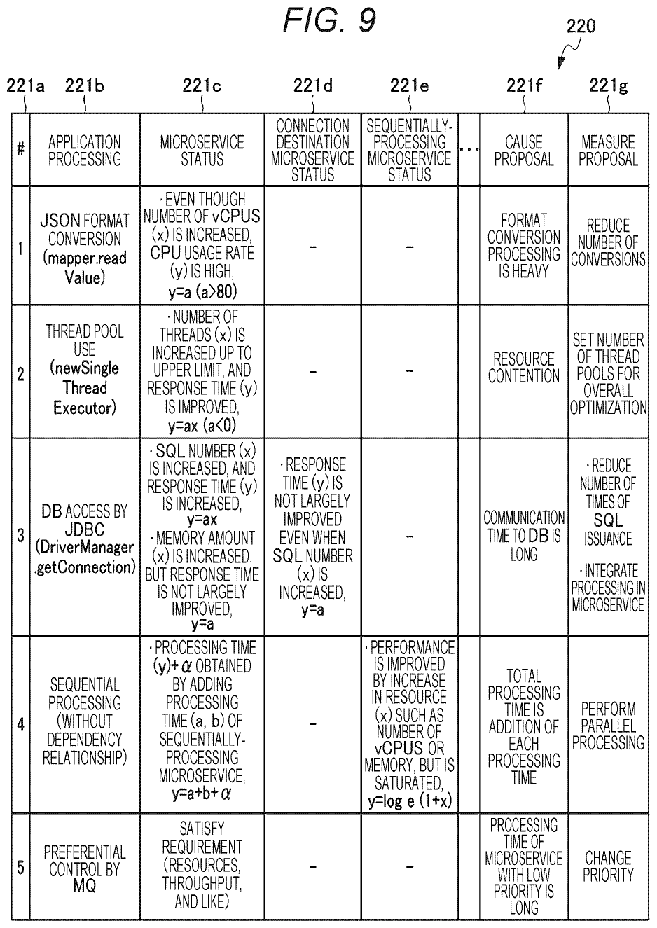

Next, the performance degradation causal information table 220 will be described with reference to FIG. 9.

FIG. 9 is a diagram illustrating a data configuration example of the performance degradation causal information table 220 according to the embodiment of the present invention. In the performance degradation causal information table, information such as application processing, a status of performance and resources, and a cause proposal and a measure proposal for performance degradation is stored as performance degradation causal information. The performance degradation causal information is defined in advance by using, for example, know-how, the artificial intelligence (AI) technique, or the like. The performance degradation causal information may include log information. For example, information obtained by collecting log information is stored by utilizing a generative AI.

The performance degradation causal information table 220 illustrated in FIG. 9 includes data items of “identification information (#)”, “application processing”, “microservice status”, “connection destination microservice status”, “sequentially-processing microservice status”, “cause proposal”, and “measure proposal”.

An identification information field 221a stores information for identifying a record of the performance degradation causal information table. In this example, the identification information is a number, but is not limited to this example.

Similarly to FIG. 6, an application processing field 221b stores information indicating the content of processing executed for each target microservice or application. information of the application processing is information indicating a cause of performance degradation (which processing degradation has occurred in).

A microservice status field 221c stores information of the microservice indicating a situation (state) corresponding to performance degradation of the microservice that performs the application processing defined in the application processing field 221b.

A connection destination microservice status field 221d stores information indicating a situation (state) corresponding to performance degradation of a connection destination microservice that is a related microservice of the microservice.

A sequentially-processing microservice status field 221e stores information indicating a situation (state) corresponding to performance degradation of the microservice to perform sequential processing in cooperation with the microservice.

Information about the microservice status, the connection destination microservice status, and the sequentially-processing microservice status, which are described above, is information to be compared with the test result (which MS is in what condition at the time of performance degradation). The information about the status of each microservice is expressed by a function in the present embodiment.

Although not illustrated in FIG. 9, additionally, there are a resource-sharing microservice status field, a preferentially-controlled microservice status field, and the like in correspondence with the application processing information table 210 (see FIG. 6).

A cause proposal field 221f stores detailed information (cause proposal) about the cause of the performance degradation of the application processing performed in the microservice.

A measure proposal field 221g stores information (measure proposal) indicating a measure for improving the state in which the performance of the application processing has been degraded.

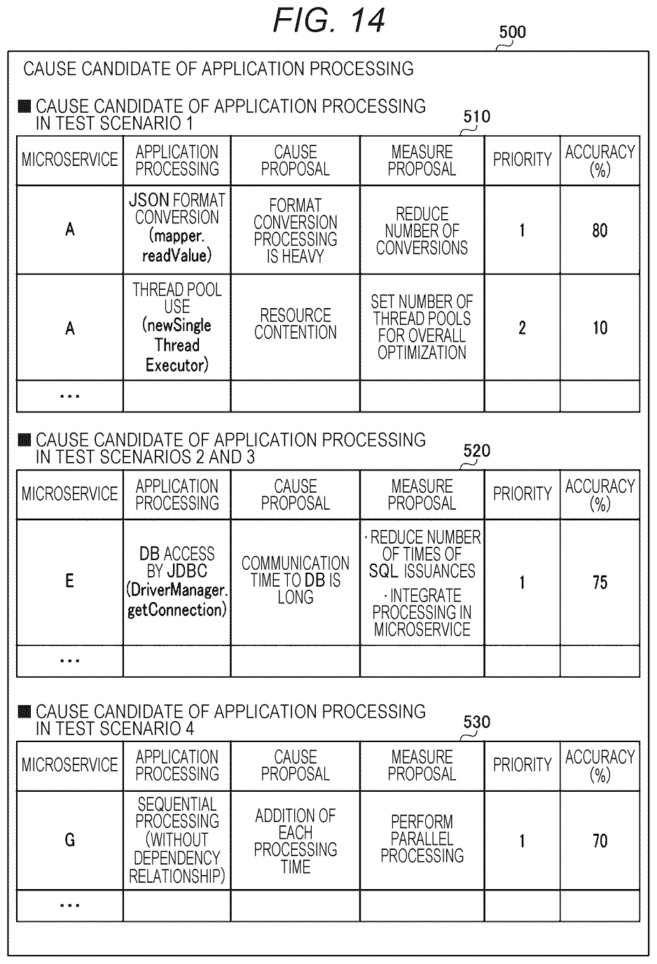

The information of the cause proposal and the measure proposal corresponds to a cause proposal and a measure proposal presented to the user in FIG. 14 which will be described later.

In the example illustrated in FIG. 9, regarding the application processing of “JSON format conversion”, “even though the number of vCPUs (x) is increased, the CPU usage rate (y) is high, y=a (a>80)” is defined as the microservice status, “heavy format conversion processing” is defined as the cause proposal, and “reduce the number of conversions” is defined as the measure proposal.

Regarding the application processing of “thread pool use”, “the number of threads (x) being increased up to upper limit, and the response time (y) being improved, y=ax (a<0 )” is defined as the microservice status. “Resource contention” is defined as the cause proposal, and “set the number of thread pools for overall optimization” is defined as the measure proposal. Although not illustrated in FIG. 9, for example, “the number of threads (x) being increased up to upper limit, and the response time (y) being increased, y=ax (a>0 )” is defined as the resource-sharing microservice status.

Regarding the application processing of “DB access by JDBC”, “SQL number (x) being increased, and the response time (y) being increased, y =ax” and “memory amount (x) is increased, but the response time is not largely improved, y =a” are defined as the microservice status. “SQL number (x) is increased, but the response time (y) is not largely improved, y =a” is defined as the destination microservice status. “Communication time to DB is long” is defined as the cause proposal, and “reduce the number of times of SQL issuance” and “integrate processing in microservice” are defined as the measure proposal. The increase in the response time includes a case where the response time increases by a predetermined value or more and a case where the response time increases by a predetermined ratio or more.

Regarding the application processing of “sequential processing (without dependency relationship)”, “processing time (y)+α is obtained by adding the processing time (a, b) of the sequentially-processing microservice, y=a+b+α” is defined as the microservice status. “Resource (x) such as the number of vCPUs and the memory is increased, and performance is improved, but is saturated, y=log e(1+x)” is defined as the sequentially-processing microservice status. “The total processing time is addition of each processing time” is defined as the cause proposal, and “perform parallel processing” is defined as the measure proposal.

Regarding the application processing of “preferential control by MQ”, “satisfy the requirement (resource, throughput, and the like)” is defined as the microservice status. “The processing time of a microservice with a low priority is long” is defined as the cause proposal, and “change the priority” is defined as the measure proposal. Although not illustrated in FIG. 9, for example, “increase in response time of the microservice with a low priority” is defined as the microservice status as the preferential control target.

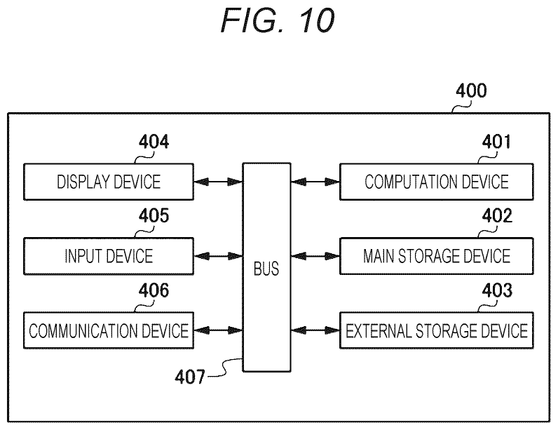

Here, a hardware configuration of a control system of the test support device 100 will be described with reference to FIG. 10.

FIG. 10 is a block diagram illustrating a hardware configuration example of the test support device 100.

A computer 400 illustrated in FIG. 10 is an example of hardware used as a computer. The test support device 100 realizes test support processing performed by the functional blocks illustrated in FIGS. 1 and 2 in cooperation with each other by the computer 400 (computer) executing a program.

The computer 400 includes a computation device 401, a main storage device 402, and an external storage device 403, which are connected to a system bus 407. The computer 400 further includes a display device 404, an input device 405, and a communication device 406. The computation device 401 is a processor such as a central processing unit (CPU). The main storage device 402 is a memory such as a random access memory (RAM). The external storage device 403 is a nonvolatile storage. The computation device 401 and the main storage device 402 are examples of elements constituting a control unit.

The computation device 401 reads, from the external storage device 403, program codes of software for realizing each function of the test support device 100 according to the present embodiment, loads the program codes into the main storage device 402, and executes the program codes. Variables, parameters, and the like generated in the middle of computation processing of the computation device 401 are temporarily written in the main storage device 402, and the variables, the parameters, and the like are appropriately read by the computation device 401. Functions of the functional blocks of the test support device 100 are realized by the computation device 401 executing the program codes. The computation device 401 may use another processor such as a micro processing unit (MPU) instead of the CPU. The program may be stored in a ROM (not illustrated).

The external storage device 403 is an example of a recording medium, and can store data used by a program, data obtained by executing the program, and the like. Each information table of the storage unit 130 (see FIG. 2) described above is configured by using the external storage device 403. As the external storage device 403, a hard disk drive (HDD), a solid state drive (SSD), an optical disk using light or magnetism, a semiconductor memory card, or the like is used. Some or all of the information tables in the storage unit 130 may be stored in a server outside the test support device 100.

The display device 404 is a monitor such as a liquid crystal display, and displays a graphical user interface (GUI) screen, a result of computation processing by the computation device 401, and the like. Some functions of the output unit 120 (see FIG. 2) described above are realized by using the display device 404.

The input device 405 generates an input signal in accordance with an operation of a user and outputs the input signal to the computation device 401. The function of the input unit 110 (see FIG. 2) described above is realized by using the input device 405. As the input device 405, for example, a mouse, a keyboard, a touch sensor, or the like is used, and the user can input information and instructions by operating the input device 405. The display device 404 and the input device 405 may be integrally configured as a touch panel.

As the communication device 406, for example, a communication device such as a network interface card (NIC) is used. The communication device 406 is connected to the public communication line 3 via a communication network such as a LAN or a dedicated line, and can transmit and receive various types of data to and from an external device such as the test target system 1. Communication of the communication device 406 may be either wired communication or wireless communication. The function of the communication unit 150 (see FIG. 2) is realized by using the communication device 406.

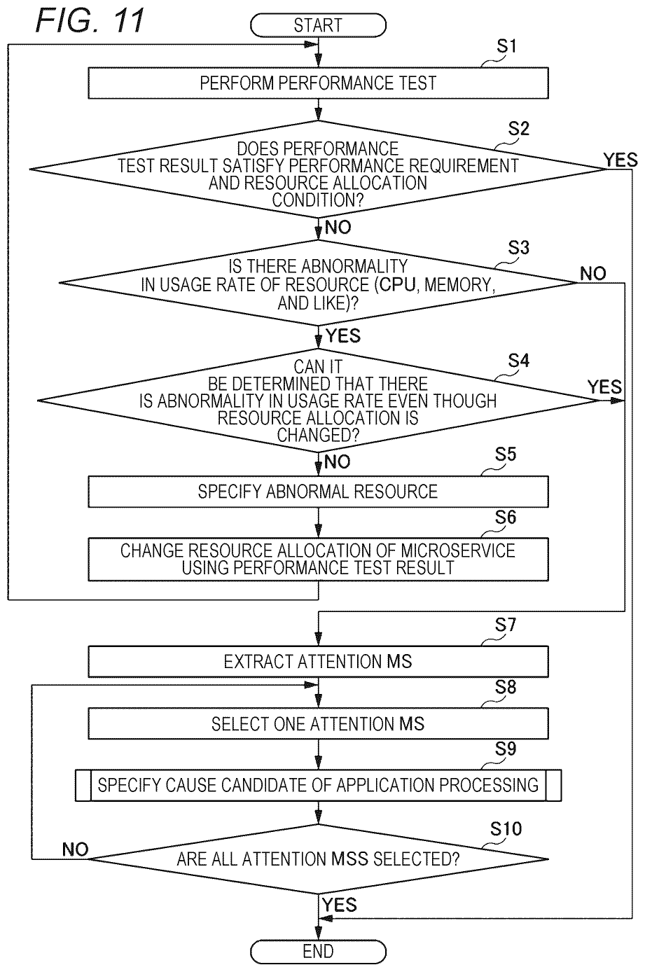

Next, a procedure example of test support processing by the test support device 100 according to the embodiment of the present invention will be described with reference to FIG. 11.

FIG. 11 is a flowchart illustrating a procedure example of the test support processing according to the embodiment of the present invention.

First, the test execution unit 300 (see FIGS. 1 and 2) performs a performance test on a microservice as a test target constituting the test target system 1 (S1). The test execution unit 300 executes the performance test on the microservice as the test target in accordance with the test scenario.

Then, the resource cause determination unit 310 determines whether or not the result of the performance test satisfies the performance requirement and the resource allocation condition (S2). That is, the resource cause determination unit 310 determines whether or not the microservice as the test target satisfies a specification required for performance and resources.

It is assumed that the performance requirement and the resource allocation condition are stored in the storage unit 130. The performance requirement is the response time, the throughput, or the like. The resource allocation condition is the CPU usage rate, the memory usage rate, or the like. In a case where the result of the performance test satisfies the performance requirement and the resource allocation condition (YES in S2), this processing ends.

For example, in a case where the CPU usage rate of the microservice is equal to or more than a target value (for example, 80%), it is conceivable that there is a problem in resource allocation to the microservice (NO in S2). In Step S2, even if the result of the performance test satisfies the resource allocation condition (target value), if there is excessive or unnatural resource allocation, it may be finally determined that the resource allocation condition is not satisfied (NO in S2). For example, in a case where the resource allocation does not satisfy a certain condition, such as a case where the CPU usage rate is always less than a predetermined setting value (for example, 20%), it is determined that the result of the performance test does not satisfy the resource allocation condition.

In this manner, in a case where the microservice does not satisfy at least one of the performance requirement or the resource allocation condition of the microservice, the resource cause determination unit 310 determines that the microservice does not satisfy the specification required for the performance or the resource. Hereinafter, the fact that the microservice does not satisfy the performance requirement or/and the resource allocation condition of the microservice is referred to as “poor in performance or/and resource”.

The target value is a value representing performance or resource allocation that is aimed or desired by the MS (application processing) or the information system. The setting value can be said to be a value for determining a possibility of the excessive or unnatural performance or resource allocation of the MS (application processing) or the information system, or abnormality. The target value and the setting value may be rephrased as a first threshold value and a second threshold value. The target value and the setting value may be determined by a person in consideration of a conventional value, and desirable performance or resource allocation of the MS. Alternatively, a system used for development or test may automatically determine the target value or the setting value in consideration of the conventional value, and the desired performance or resource allocation of the MS.

In a case where the result of the performance test does not satisfy the performance requirement or the resource allocation condition (NO in S2), the resource cause determination unit 310 determines whether or not there is an abnormality in the usage rate of the resource (CPU, memory, and the like) (S3).

The abnormality of the resource usage rate is that the resource usage rate is constantly large or small, a rapid increase or decrease occurs, or the like. In a case where there is no abnormality in the resource usage rate (NO in S3), the processing proceeds to Step S7. In the case of NO in Step S3, the performance of the microservice is poor, and the resource is favorable. That is, it is estimated that only the performance is poor and there is a problem in the application. In a case where an abnormality is detected in the resource usage rate in the general performance test, test processing ends here.

In a case where there is the abnormality in the resource usage rate (YES in S3), the resource cause determination unit 310 determines whether or not it can be determined that there is an abnormality in the resource usage rate even if the resource allocation is changed (S4). For example, the resource cause determination unit 310 makes a determination by looking at test results of performance tests of different resource allocations performed a plurality of times in the past. In the case of YES in Step S3, at least the resource is poor regardless of the quality of the performance.

In a case where it can be determined that there is the abnormality in the resource usage rate (YES in S4), the processing proceeds to Step S7. In the case of YES in Step S4, at least the resource is poor regardless of the quality of the performance. In a case where it can be determined that there is the abnormality in the resource usage rate even if the resource allocation is changed, it can be estimated that there is a problem in the application.

In a case where it is determined that there is no abnormality in the resource usage rate even if the resource allocation is changed (NO in S4), the resource cause determination unit 310 extracts a microservice having an abnormal value in the resource and specifies a resource having an abnormal value (S5). In Step S5, an abnormal microservice and an abnormal resource in the abnormal microservice are specified.

Then, the resource cause determination unit 310 changes the resource allocation of the system (microservice) using the result of the performance test (S6).

For example, the resource cause determination unit 310 executes processing of sequentially increasing the number of vCPUs or/and the allocation of the memory capacity, setting the allocation of a value higher than a predetermined current value, or the like. In a case where the resource usage rate is lower than the setting value (for example, 20%), the resource cause determination unit 310 executes processing of reducing the resource allocation because the resource allocation is too large. After the process of Step S6, the resource cause determination unit 310 proceeds to Step S1 and performs a performance test after changing the resource allocation.

In Steps S3 to S5 described above, it is desired to isolate whether the cause is the resource allocation or the application processing with respect to being poor in the performance or/and the resource of the microservice.

Therefore, the resource cause determination unit 310 changes the resource allocation in Step S6 and repeats the performance test in Step S1. As a result, in a case where the resource usage rate of the microservice is not higher than the predetermined value and the microservice does not satisfy the performance requirement (corresponding to NO in S3), or in a case where it can be determined that there is an abnormality in the resource usage rate even if the resource allocation of the microservice is increased (corresponding to YES in S4), the resource cause determination unit 310 determines that the cause of being poor in the performance or/and the resource of the microservice is in the application performed in the microservice.

For example, the case where the resource allocation is the cause means when the allocated resource is insufficient or excessive. In addition, it is conceivable that the case where the application processing is the cause means an inappropriate setting value in the program, a bug in the source code, or the like.

As described above, in a case where it is not possible for the resource cause determination unit 310 to determine that the cause of being poor in the performance or/and the resource of the microservice is in the application performed in the microservice, the resource allocation of the microservice is increased or decreased. After the resource allocation of the microservice is increased or decreased, the test execution unit 300 executes the performance test of the microservice again.

As a result, in the present embodiment, even if it is not possible to perform the cause isolation of the resource/application before the change of the resource allocation, it is possible to perform the cause isolation of the resource/application after the resource allocation is changed.

In a case where there is no abnormality in the resource usage rate (NO in S3) or in a case where it can be determined that there is an abnormality in the resource usage rate even if the resource allocation is changed (YES in S4), the application cause determination unit 320 extracts a microservice (attention MS) having an abnormal value in the performance or the resource (S7). The number of attention MSs is not limited to one.

Then, the application cause determination unit 320 selects one attention MS (application processing) from one or more attention MSs (application processing) (S8).

Here, the application cause determination unit 320 specifies and selects which MS (application processing) has degraded in performance. For example, the application cause determination unit 320 specifies an MS (application processing) having a large difference from the actual value or the target value of the unit test of each MS (application processing).

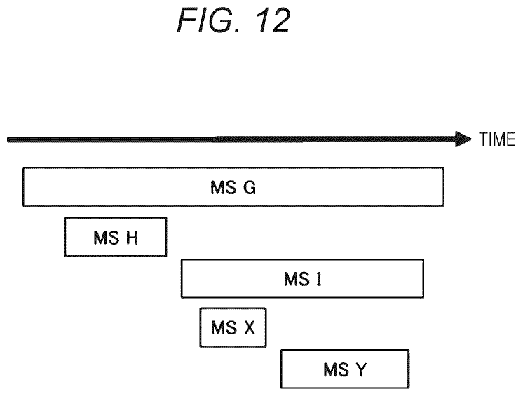

Here, the processing of selecting the attention MS in Step S8 will be described with reference to FIG. 12.

FIG. 12 is a diagram illustrating an example of selecting the attention MS for a nested structure MS.

In FIG. 12, the MS G cooperates with the MS H and the MS I, and the MS H and the MS I are sequentially processed in the same manner as in the example illustrated in the upper part of FIG. 7. Here, the MS H and the MS I have a nested structure (hierarchical structure) with respect to the MS G. The MS I cooperates with the MS X and the MS Y, and the MS X and the MS Y sequentially perform processing. The MS X and the MS Y have a nested structure with respect to the MS I. In the nested structure, the number of hierarchies is also expressed as the depth of the hierarchy.

For example, in the sequential processing, the response time of the MS G is long, but actually, the processing of the MS I is long. As a first selection method, an MS (application processing) having a large actual value (for example, response time) of the unit test of each MS or having a large difference from the target value is specified and selected as the attention MS. As a second selection method, in the MS having the nested structure, the MSs are specified in order from the MS that executes the deepest processing, and selected as the attention MS. Regarding the depth of the nested structure, the MS H and the MS I are the same, and the MS X and the MS Y in the further lower layer are the same. The deepest processing corresponds to, for example, application processing of the MS X or the MS Y in the deepest hierarchy in the MS having the nested structure in FIG. 12.

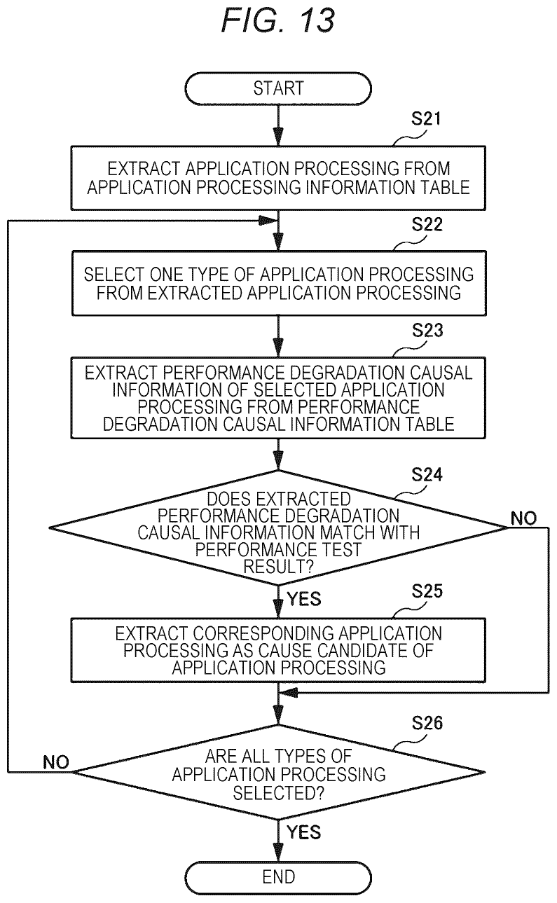

Then, the application cause determination unit 320 specifies a cause candidate of the application processing for the selected attention MS (S9). Details of the processing in Step S9 will be described with reference to FIG. 13 which will be described later.

Next, the application cause determination unit 320 determines whether or not all the attention MSs have been selected (S10). In a case where not all the attention MSs are selected (NO in S10), the application cause determination unit 320 proceeds to Step S8 and continues the processing. In a case where all the attention MSs are selected (YES in S10), the application cause determination unit 320 ends this processing.

In a case where there is a microservice that has not been tested in the same test case, the test execution unit 300 performs the performance test on the microservice. In a case where the performance test is performed on all the microservices as the test targets in the same test case, the test execution unit 300 performs the performance test of the microservice on the remaining test cases. The test execution unit 300 performs the performance test of the microservice as the test target in all the test cases in the same test scenario.

Although the resource cause determination unit 310 executes the processing in Steps S2 to S4, the test execution unit 300 or the application cause determination unit 320 may be configured to perform this processing.

Next, details of the processing in Step S9 illustrated in FIG. 11 will be described with reference to FIG. 13.

FIG. 13 is a flowchart illustrating a procedure example of processing of specifying a cause candidate of the application processing in Step S9 of FIG. 11.

After the processing in Step S8, the application cause determination unit 320 extracts all types of the application processing executed by the attention MS selected in Step S8, from the application processing information table 210 (see FIG. 6) (S21). For example, in a case where the attention MS is the MS A, “JSON format conversion” and “thread pool use” are extracted as the application processing.

Then, the application cause determination unit 320 selects one type of application processing from the types of application processing extracted in Step S21 with reference to the application processing information table 210 (S22).

Then, the application cause determination unit 320 extracts the performance degradation causal information regarding the application processing selected in Step S22 from the performance degradation causal information table 220 (see FIG. 9) (S23).

Then, the application cause determination unit 320 determines whether or not the performance degradation causal information extracted in Step S23 matches with the result of the performance test (S24). The determination of the match is not limited to perfect match, and it may be determined that both match when a match degree of a predetermined value or more is obtained.

For example, the application cause determination unit 320 utilizes a statistical analysis method (principal component analysis, correlation coefficient, or the like) to determine whether both pieces of information match with each other. In the principal component analysis method, which x or y of the performance degradation causal information (each microservice status) the result of the performance test is related to is computed. In the method using a correlation coefficient, similarity of data is computed. Alternatively, the application cause determination unit 320 may determine whether the result of the performance test satisfies the performance degradation causal information (each microservice status) by utilizing the log information, the generative AI, or the like.

In a case where the performance degradation causal information extracted in Step S24 matches with the result of the performance test (YES in S24), the application cause determination unit 320 extracts the corresponding application processing as the cause candidate of the application processing (S25).

Although it is determined as YES or NO in Step S24 described above, the present invention is not limited to this example. For example, as illustrated in a cause candidate screen 500 of the application processing in FIG. 14 which will be described later, a plurality of or all cause candidates may be extracted with priority or accuracy of the cause candidates.

After the processing in Step S25 or in a case where the performance degradation causal information extracted in Step S24 does not match with the result of the performance test (NO in S24), the application cause determination unit 320 determines whether or not all types of the application processing have been selected (S26). In a case where not all types of the application processing have been selected (NO in S26), the application cause determination unit 320 proceeds to Step S22 and selects another application processing. In a case where all the types of application processing are selected (YES in S26), the application cause determination unit 320 ends this processing.

The application cause determination unit 320 outputs, by the output unit 120, information of the cause candidate of the application processing extracted for each test scenario. The information of the cause candidate of the application processing, which is output from the output unit 120, is displayed on the cause candidate screen 500 of the application processing on the display device 404, for example. In a case where application processing that is the cause candidate is not finally extracted, the application cause determination unit 320 may display that there is no cause candidate of the application processing.

As described above, the test support device 100 according to the present embodiment includes the test execution unit (test execution unit 300), the resource cause determination unit (resource cause determination unit 310), and the application cause determination unit (application cause determination unit 320).

The test execution unit executes a performance test on the microservice as the test target, and acquires a result (for example, the performance test result information table 200) of the performance test.

In a case where the resource cause determination unit determines that the microservice is poor in performance or/and a resource from the result of the performance test, the resource cause determination unit determines whether a cause of being poor in the performance or/and the resource of the microservice is in an application implemented in the microservice or in the resource of the microservice.

In a case where it is determined that the cause of being poor in the performance or/and the resource of the microservice is in the application executed in the microservice, the application cause determination unit determines application processing as a cause candidate from a relationship between the application processing and the result of the performance test.

In addition, the test support device 100 according to the present embodiment includes the application processing information storage unit (application processing information table 210) that stores information of a microservice and application processing information executed by the microservice in association with each other, and the causal information storage unit (performance degradation causal information table 220) that stores information of application processing and information regarding a situation at the time of being poor in the performance or/and the resource of the microservice in association with each other.

The application cause determination unit (application cause determination unit 320) compares the result of the performance test of the microservice with the information regarding the situation at the time of being poor in the performance or/and the resource of the microservice, which is stored in the causal information storage unit, and determines, as the cause candidate, application processing associated with the information regarding the situation at the time of being poor in the performance or/and the resource of the microservice in a case where the result of the performance test matches with the information regarding the situation at the time of being poor in the performance or/and the resource of the microservice.

According to the above-described test support device 100 according to the present embodiment, it is possible to isolate and specify the cause of the resource/application at the time of performance degradation of a test target in a performance test. Thus, in the test support device 100, it is possible to improve the efficiency of the cause analysis of the resource/application at the time of performance degradation of the test target in the performance test.

In addition, in the test support device 100 according to the present embodiment, the causal information storage unit (performance degradation causal information table 220) further stores the microservice and the information regarding the situation at the time of being poor in performance or/and a resource of the related microservice (related MS) having a relation in performance or/and a resource with the microservice, in association with each other. The application cause determination unit (application cause determination unit 320) further determines application processing as the cause candidate in consideration of the result of the performance test of the related microservice and the information regarding the situation at the time of being poor in the performance or/and the resource of the related microservice.

As a result, the test support device 100 can perform the performance test in consideration of the relation between the microservices (application processing) in the integration test and the system test. For example, since the performance test can be performed by including the business logic and the relation of an MS group in the relation between the MSs (application processing), these relations can be reflected in the result of the performance test.

Next, a display screen displaying the cause candidate of the application processing will be described with reference to FIG. 14.

FIG. 14 is a diagram illustrating an example of the display screen that displays the cause candidate of the application processing according to the embodiment of the present invention.

In FIG. 14, the cause candidate screen 500 of the application processing displays the cause candidate of the application processing for each test scenario. FIG. 14 illustrates an example in which the cause candidate screen 500 of the application processing displays a cause candidate list 510 of the application processing of the test scenario 1, a cause candidate list 520 of the application processing of the test scenarios 2 and 3, and a cause candidate list 530 of the application processing of the test scenario 4.

The cause candidate list of the application processing includes items of “microservice”, “application processing”, “cause proposal”, “measure proposal”, “priority”, and “accuracy”.

The item of the microservice indicates information for specifying the microservice including the application processing extracted as the cause candidate. This item corresponds to the microservice fields 201c and 211b of the performance test result information table 200 and the application processing information table 210.

The item of the application processing indicates the content of the application processing of the cause candidate. This item corresponds to the application processing fields 211c and 221b of the application processing information table 210 and the performance degradation causal information table 220.

The item of the cause proposal indicates detailed information (cause proposal) about the cause of the performance degradation of the application processing performed in the corresponding microservice. This item corresponds to the cause proposal field 221f of the performance degradation causal information table 220. The item of the measure proposal indicates a measure (measure proposal) for improving the state in which the performance of the application processing is degraded. This item corresponds to the measure proposal field 221g of the performance degradation causal information table 220.

The item of the priority indicates the priority of the cause candidate of the application processing in a case where there are a plurality of cause candidates of the application processing in the same test scenario. As the priority becomes higher, the value is reduced. The priority is given to each cause candidate of the application processing.

The item of the accuracy indicates the accuracy (%) of the cause candidate of the application processing displayed in the item of the application processing. The accuracy is given to each cause candidate of the application processing.

In the cause candidate list 510 of the application processing of the test scenario 1, for the microservice A, “JSON format conversion (mapper. readValue)” is displayed as the application processing of the cause candidate, “heavy format conversion processing” is displayed as the cause proposal, and “reduce the number of conversions” is displayed as the measure proposal. Further, the priority of “1” and the accuracy of “80” are displayed. In the cause candidate list 510 of the application processing of the test scenario 1, for the microservice A, “thread pool use (newSingleThreadExecutor)” is displayed as the application processing of the cause candidate, “resource contention” is displayed as the cause proposal, and “set the number of thread pools for overall optimization” is displayed as the measure proposal. Further, the priority of “2” and the accuracy of “10” are displayed.

In the cause candidate list 520 of the application processing of the test scenarios 2 and 3, for the microservice E, “DB access with JDBC (DriverManager.getConnection)” is displayed as the application processing of the cause candidate, “the communication time to the DB is long” is displayed as the cause proposal, and “reduce the number of times of SQL issuance” and “integrate processing in microservice” are displayed as the measure proposal. Further, the priority of “1” and the accuracy of “75” are displayed.

In the cause candidate list 530 of the application processing of the test scenario 4, for the microservice G, “sequential processing (without dependency relationship)” is displayed as the application processing of the cause candidate, “addition of each processing time” is displayed as the cause proposal, and “perform parallel processing” is displayed as the measure proposal. Further, the priority of “1” and the accuracy of “70” are displayed.

In the example of FIG. 14, two measure proposals are displayed for one cause candidate of the application processing. However, in a case where there is a measure that should not be combined, the measure that should not be combined may be displayed in the display of the measure proposal.

As described above, in the test support device 100 according to the present embodiment, the application cause determination unit (application cause determination unit 320) performs control such that at least the microservice as the test target and the application processing as the cause candidate are displayable.

In the present embodiment, the application cause determination unit (application cause determination unit 320) further performs control such that detailed information (cause proposal) about the cause of being poor in the performance or/and the resource of the application processing as the cause candidate and a measure (measure proposal) for improving the state of being poor in the performance or/and the resource are displayable.

Furthermore, in the present embodiment, in a case where there are a plurality of types of application processing as cause candidates, the application cause determination unit (application cause determination unit 320) further performs control such that the priority and the accuracy are displayable for each of the plurality of types of application processing as cause candidates.

With such a cause candidate screen 500 of the application processing, the user can check the cause (microservice and application processing) of the performance degradation, the details (cause proposal) thereof, and the measure proposal. The user can check the priority and the accuracy with respect to each of the plurality of types of application processing as the cause candidates. As a result, the user can efficiently perform the cause analysis of the resource/application at the time of performance degradation of the test target in the performance test. In addition, the user can realize resource allocation without excess or deficiency to the microservice, setting of an application parameter value, and optimization of the target value of the performance, by checking the cause candidate screen 500 of the application processing.

Hitherto, the present invention is not limited to the above-described embodiment, and it goes without saying that various other modification examples and application examples can be taken as long as the gist of the present invention described in the claims is not deviated. For example, the above-described embodiment describes the configurations thereof in detail and concretely in order to describe the present invention in an easy-to-understand manner, and is not necessarily limited to those including all the described constituent elements. Regarding a portion of the configuration in the above-described embodiment, other constituent elements can also be added, replaced, and deleted.

In addition, each constituent element of the test support device according to the above-described embodiment may be implemented in any piece of hardware as long as the hardware can transmit and receive information to and from each other via a network. The processing performed by a certain processing unit may be realized by one piece of hardware or may be realized by distributed processing by a plurality of pieces of hardware.

In addition, in the present specification, the processing steps describing the time-series processing include not only processing performed in time series in accordance with the described order, but also processing that is not necessarily performed in time series and is executed in parallel or individually (for example, processing by an object). Furthermore, the processing order of the processing steps may be changed within a range not affecting the processing result.

What is claimed is:

1. A test support device comprising:
a test execution unit that executes a performance test on a microservice as a test target and acquires a result of the performance test;
a resource cause determination unit that determines, in a case where it is determined from the result of the performance test that the microservice is poor in performance or/and resources, whether a cause of being poor in the performance or/and the resources of the microservice is in an application implemented in the microservice or in resources of the microservice; and
an application cause determination unit that determines, in a case where it is determined that the cause of being poor in the performance or/and the resources of the microservice is in the application implemented in the microservice, determines application processing as a cause candidate from a relationship between the application process and the result of the performance test.

2. The test support device according to claim 1, further comprising:
an application processing information storage unit that stores information of the microservice and information of an application process executed by the microservice in association with each other; and
a causal information storage unit that stores the information of the application processing and information regarding a situation at time of being poor in the performance or/and a resource of the microservice in association with each other, wherein
the application cause determination unit compares the result of the performance test of the microservice with the information regarding the situation at the time of being poor in the performance or/and the resource of the microservice, which is stored in the causal information storage unit, and determines, in a case where the result of the test result matches with the information regarding the situation at the time of being poor in the performance or/and the resource of the microservice, the application processing associated with the information regarding the situation at the time of being poor in the performance or/and the resource of the microservice, as the cause candidate.

3. The test support device according to claim 2, wherein
the resource cause determination unit determines that the microservice is poor in the performance or/and the resource in a case where the microservice does not satisfy at least one of a performance requirement or a resource allocation condition of the microservice.

4. The test support device according to claim 3, wherein
in a case where the resource usage rate of the microservice is not higher than a predetermined value and the microservice does not satisfy the performance requirement, or in a case where the performance of the microservice is not improved even if the resource allocation of the microservice is increased or decreased, the resource cause determination unit determines that the cause of being poor in the performance or/and the resource of the microservice is in an application implemented in the microservice.

5. The test support device according to claim 4, wherein
the resource allocation of the microservice is increased or decreased in a case where it is not possible for the resource cause determination unit to determine that the cause of being poor in the performance or/and the resource of the microservice is in the application implemented in the microservice, and
after the resource allocation of the microservice is increased or decreased, the test execution unit performs the performance test of the microservice again.

6. The test support device according to claim 2, wherein
the causal information storage unit further stores the microservice and information regarding a situation of being poor in performance or/and a resource of a related microservice that has a relation in performance or resource with the microservice, in association with each other, and
the application cause determination unit further determines the application processing as the cause candidate in consideration of a result of the performance test of the related microservice and information regarding a situation at time of being poor in the performance or/and the resource of the related microservice.

7. The test support device according to claim 6, wherein
the relation between the microservice and the related microservice is a relation based on business logic.

8. The test support device according to claim 1, wherein
the application cause determination unit performs control such that at least the microservice and the application processing as the cause candidate are displayable.

9. The test support device according to claim 8, wherein
the application cause determination unit further performs control such that detailed information regarding a cause of being poor in performance or/and a resource of the application processing as the cause candidate, and a measure for improving a state of being poor in the performance or/and the resource are displayable.

10. The test support device according to claim 9, wherein
in a case where there are a plurality of types of application processing as the cause candidates, the application cause determination unit further performs control such that priority and accuracy are displayable for each of the plurality of types of application processing as the cause candidates.
